(19) United States
(12) Patent Application Publication
(10) Pub. No.: US 2005/0092804 A1
(43) Pub. Date: May 5, 2005

(54) Tape moving device for an adhesive tape holder

(76) Inventor: Hsiu-Man Yu Chen, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/697,152

(22) Filed: Oct. 31, 2003

(51) Int. Cl. B26F 3/02; B65H 35/10

(52) U.S. Cl. 225/93

(57) ABSTRACT

A tape-moving device for an adhesive tape holder includes a plurality of gears and a handle. The handle can be swung down to rotate together a main gear and an intermediate gear and then a feeding gear in order. The feeding gear has an annular corrugated multi-stage wing for an adhesive tape to stick on. Then the adhesive tape can be pulled out for a restricted length with the feeding gear for a limited length when the handle is swung down and stopped by a limit button adjustably fixed at any point of a curved position groove provided in a holder body. And a knife blade cuts off the tape at the preset length pulled out by the feeding gear.

### BACKGROUND OF THE INVENTION

1. Field of the Invention

This invention relates to an adhesive tape holder, particularly to one having a tape-moving device having of a handle for adjusting the number of gear teeth of a gear to move forward the needed length of an adhesive tape to be used and cut off.

2. Description of Prior Arts

A common adhesive tape holder shown in FIG. 1 includes a holder body 1, a hollow 2 formed in the holder body 1 for pivotally positioning a rotatable roller 3 for putting a adhesive tape roll on, a knife base 4 fixed on an upper end of a front side, and a knife blade 5 fixed to face inward on the knife base 4. In using the tape holder, the adhesive tape is manually pulled forward for a needed length and cut off by the knife blade 5, with the unused tape end temporarily adhered on the knife blade 5 for next round of use,

However, in using the conventional tape holder, a user has to push firmly the tape holder with one hand and to pull the tape out with the other hand, inconvenient to handle. Further, the adhesive tape on the rotatable roller 3 must be pulled by one hand, so if the hand is not clean, maybe a little oily or dirty, then the tape may be smeared with the oil or dirt. Then the adhesiveness of the tape may worsen. Besides, the needed length of the tape may not be correct owing to eyesight, too long or too short, not easy to judge.

### SUMMARY OF THE INVENTION

The purpose of the invention is to offer a tape-moving device for an adhesive tape holder, which includes a plurality of gears engaging with one another and a handle provided outside of the holder body and connected with a main gear. The handle is pressed down to a preset location to rotate the main gear and then an intermediate gear and then a feeding gear provided with an annular corrugated multi-stage wing for the adhesive tape to be temporarily stuck on. Then the feeding gear rotates and at the same time pulls out the adhesive tape for a present length for use by the handle restricted in its moving distance to be pressed down by means of a position button moved adjustably and fixed at any point of a curved position groove in the holder body for stopping the handle when pressed down.

### BRIEF DESCRIPTION OF DRAWINGS

This invention will be better understood by referring to the accompanying drawings, wherein:

FIG. 1 is a perspective view of a conventional adhesive tape holder;

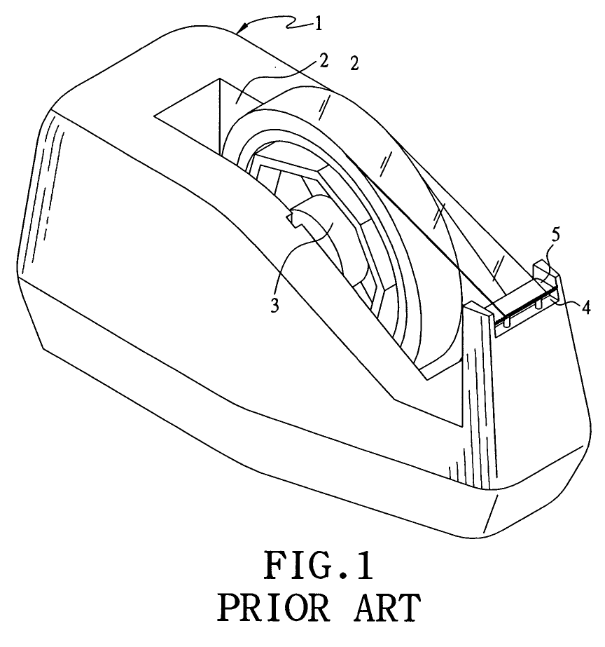

FIG. 2 is a perspective view of an adhesive tape holder provided with a tape-moving device in the present invention;

FIG. 3 is an exploded perspective view of the adhesive tape holder provided with a tape-moving device in the present invention;

FIG. 4 is a side view of the tape-moving device in the present invention;

FIG. 5 is a side view of another embodiment of a tape moving device in the present invention; and,

FIG. 6 is a partial exploded perspective view of another embodiment of tape moving device shown in FIG. 5.

### DETAILED DESCRIPTION OF THE PREFERRED EMBODIMENT

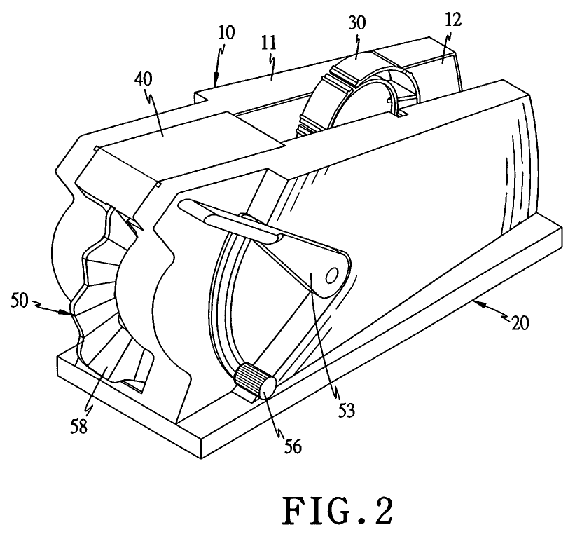

A preferred embodiment of a tape-moving device 50 for an adhesive tape holder in the present invention, as shown in FIG. 2, 3 and 4, is combined with a tape holder body 10, a body base 20, a rotatable roller 30, and a cover 40.

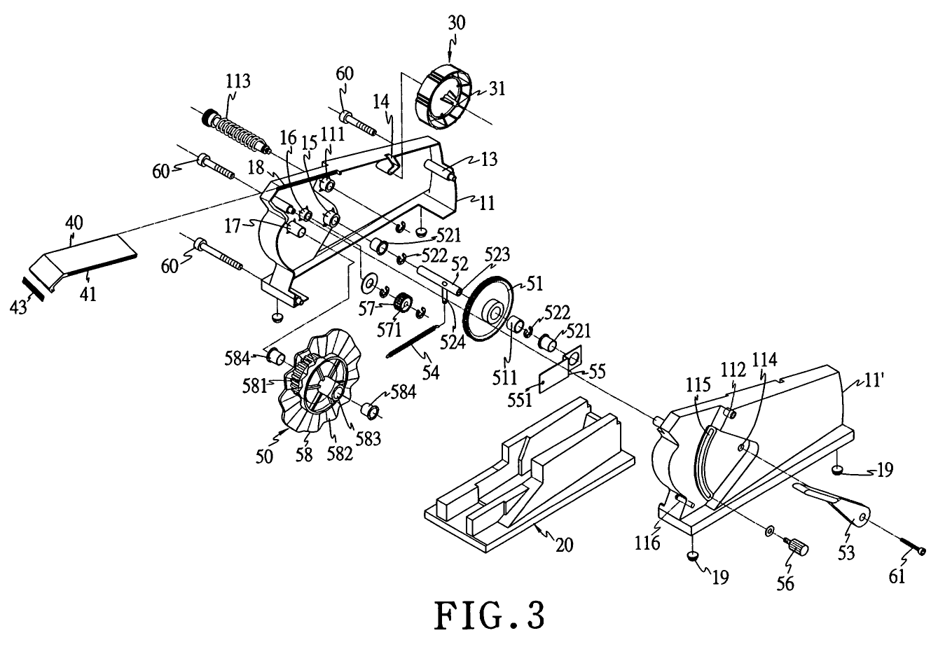

As shown in FIGS. 2 and 3, the holder body 10 consists of two half shells, a first half shell 11 and a second half shell 11′, having a hollow 12, a plurality of sidewise posts 13 formed respectively corresponding to each other in the two half shells 11 and 11′, a plurality of screws 60 combining together the two half shells 11, 11′. Each half shell 11, 11′ has an L-shaped receiving groove 14 in the upper center portion, a first shaft tube 15 provided sidewise in the center portion to face each other, a second shaft tube 16 near the first shaft tube 15 to face each other, and a third shaft tube 17 near the second shaft tube 16 to face each other. The first half shell 11 has a hole 111 in an upper center portion, and the second half shell 11′ has a threaded hole 112 aligned to the hole 111 for a pull rod 113 to pivotally fitting in the hole 111 and then screws with the threaded hole 112. The second half shell 11′ has a fitting hole 114 aligned to the first shaft tube 15, and a curved position groove 115 formed in the front portion of the wall in front of the fitting hole 14, a sidewise round post 116 positioned near the curved position groove 115 and extending inward. A rail groove 18 is respectively formed in an upper portion of each half shell 11, 11′ facing each other. The holder body 10 has two opposite anti-slide gaskets 19 on two diagonal corners of the bottom to stably position the tape holder on a flat surface.

Further, the body base 20 is located in the lower portion of the hollow 12 of the holder body 10 to utilize its weight to stabilize the tape holder in using it.

The rotatable roller 30 is positioned in the hollow 12 of the holder body 10 for an adhesive tape roll to be fitted around, having a shaft 31 extending laterally to both sides in the center and supported in the receiving grooves 14 in the holder body 10 to let the adhesive tape turn around together with the rotatable roller 30.

The plate cover 40 is closed on the top of the hollow 12 of the holder body 10, having a rail 41 formed respectively in two lengthwise sides fitting in the two rail grooves 18 of the holder body 10 and a knife blade 42 fixed with a certain-angled end portion of the cover 40 for cutting an adhesive tape.

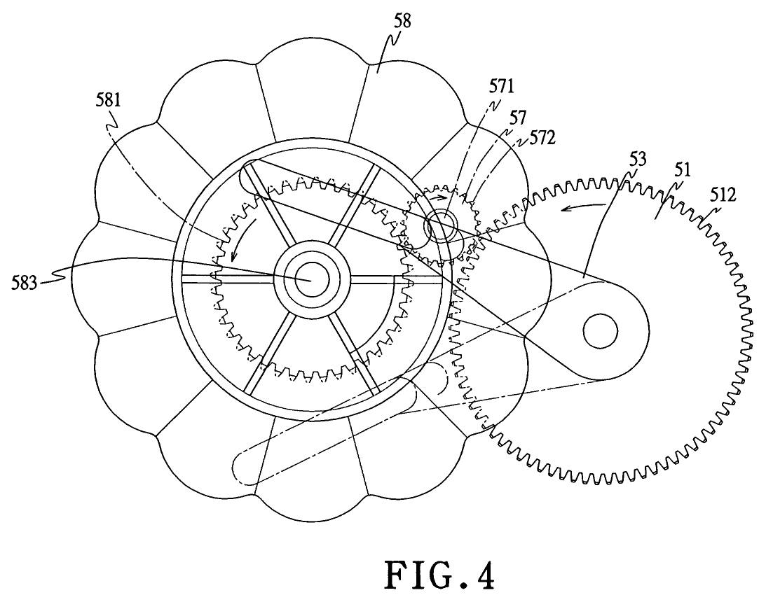

The tape moving device 50 is provided in the hollow 12 of the holder body 10, as shown in FIGS. 3 and 4, consisting of a main gear 51, an intermediate gear 57, a feeding gear 58 and a handle 53. The main gear 51 has teeth 512 on its periphery of a large diameter, a one-way bearing 511 fixed in the center of the main gear 51 for a shaft 52 to pivotally fitting in its center hole and to rotate only counterclockwise, a shaft sleeve 52 respectively and pivotally fitting around with plural locking washers 522 in the first shaft tube 15. Thus the shaft 52 may rotate smoothly, having its front end fitting through the fitting hole 114 of the second half shell 11′ and a threaded hole 523 in the front end to combine with the handle 53 at the outside of the second half shell 11′ by means of a bolt 61. Further, a vertical round bar 524 is fixed in the center section of the shaft 52, having its lower end hooked with one end of a coil spring 54 having its other end hooked with the round post 116 of the second half shell 11′. In addition, the front end of the shaft 52 fits in a position piece 55 provided with a hole 551 in its other end, and a limit button 56 is fixed in the hole 551 so that the limit button 56 can move up and down in the position groove 115 and then screwed tightly and immovably at any point of the curved position groove 115 to stop the handle 53 when the handle is pressed down so as to restrict the length of the adhesive tape to be pulled out by swinging down of the handle 53.

The second shaft tube 16 is combined with an intermediate gear 57, which has a center pivot hole 571 fitting around the second shaft tube 16, and teeth 572 engaging with the teeth 512 of the main gear 51 on one side and also engaging with the feeding gear 58 on the other side. Thus the feeding gear 58 has teeth 581 of a preset number engaging with the teeth 572 of the intermediate gear 57, an annular corrugated multi-staged wing 582, and a center shaft hole 583 for a shaft sleeve 584 to fit respectively in two sides and also to fit around the third shaft tube 17.

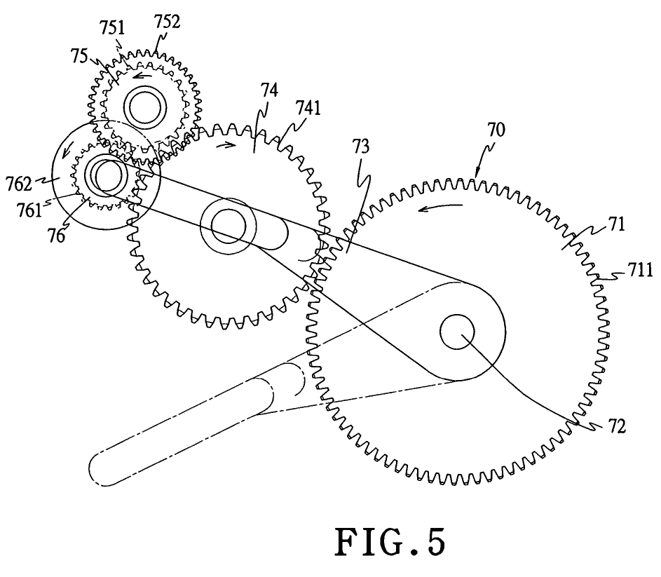

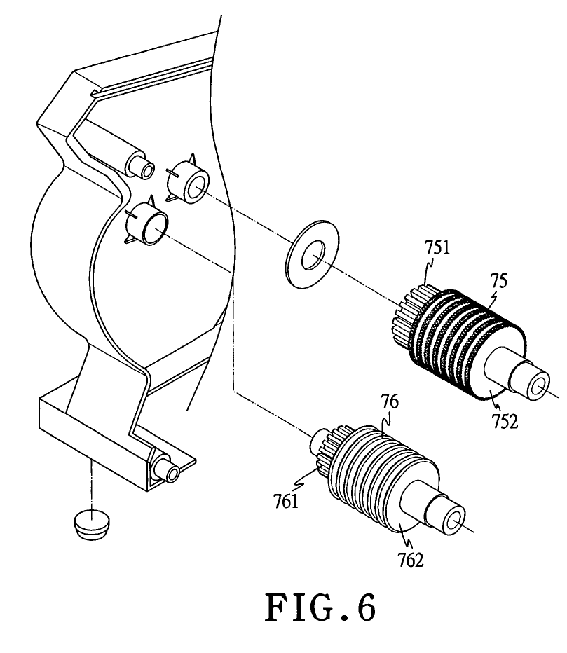

Next, another embodiment of a tape moving device 70 is shown in FIGS. 5 and 6, consisting of a main gear 71 of a large diameter with a center shaft 72, an intermediate gear 74, and two feeding gears 75 and 76 and a handle 73. The handle 73 is fixed with one end of the shaft 72 to restrict the main gear 71 to rotate only in one way, and the main gear 71 has teeth 711 of a preset number engaging with the teeth 741 of the intermediate gear 74, which then has the other side engaging with the supply gear 75. The supply gear 75 has teeth 751 engaging with the teeth 741, and the other supply gear 76 has teeth 761 engaging with the teeth 751. Further the two supply gears 75 and 76 respectively have an annular corrugated multi-stage wing 752 and 762 for an adhesive tape to temporarily stick to. In addition, the annular corrugated multi-stage wing 752 also has peripheral teeth of a preset number.

Next, how to use the adhesive tape holder is to be described. As shown in FIG. 4, when the adhesive tape is pulled out of the hollow 12, it will be stuck on the corrugated surface of the annular corrugated multi-stage wing 582 of the feeding gear 58. When the handle 53 is pressed down to force the main gear 51 rotate counterclockwise for a certain preset distance, the intermediate gear 57 will be rotated clockwise for the same length, and then the feeding gear 58 engaging with the intermediate gear 57 also rotates counterclockwise for the same length with the adhesive tape pulled out for the same length for use. Provided the handle 53 is released, it will be returned to the original position by means of recovered elasticity of the coil spring 54 and the shaft 52.

Further, there is the position piece 55 provided between the shaft 52 and the handle 53, and the position piece 55 has one end connected with the limit button 56 through the position groove 115, and the limit button 56 can be screwed tightly and unmovable at any point of position groove 115. Therefore, when the handle 53 is swung down, it is to be stopped by the limit button for a preset distance, with the main gear rotating together with the handle 53 also stopped so as to limit the length of the adhesive tape pulled out by the feeding gear 58. Thus the limit button 56 has a function for restricting effectively the length of the tape to be used.

As described above, the adhesive tape is pulled out by the feeding gear 58 in lieu of manual process, so it cannot be soiled with oil or dirt on a hand, keeping an adhesive tape in the cleanest condition, with the cover 40 separating the hollow 12 from the outside, keeping airborne dirt and micro bits of miscellaneous matters from flying in the hollow 12 to smear an adhesive tape on the rotatable roller 30.

Moreover, the second embodiment of the tape moving device shown in FIGS. 5 and 6, uses the handle 73 for revolving the main gear 71 counterclockwise, and then the intermediate gear 74 clockwise and then the two feeding gears 75 and 76 counterclockwise in order to let the annular corrugated multi-stage wings 752 and 762 move the adhesive tape for a needed length.

While the preferred embodiment of the invention has been described above, it will be recognized and understood that various modifications may be made therein and the appended claims are intended to cover all such modifications that may fall within the spirit and the scope of the invention.

1. A tape moving device for an adhesive tape holder positioned in a hollow in a holder body consisting of two half shells, said tape moving device comprising:
A main gear having a one-way bearing in its center for a shaft to fit pivotally in a center hole of said bearing, said shaft having one end connected with a handle, an intermediate gear provided to have one side engaging with said main gear, said intermediate gear having the other side engaging with a feeding gear, said feeding gear having an annular multi-stage wing for an adhesive tape to stick thereon, said main gear rotated for a limited curved distance by said handle when said handle is pressed down so that said intermediate gear and said feeding gear may be rotated for the same distance to let an adhesive tape pulled out for the same length for use.

2. The tape moving device for an adhesive tape holder as claimed in claim 1, wherein said annular multi-stage wing is shaped corrugated.

3. The tape moving device for an adhesive tape holder as claimed in claim 1, wherein said annular multi-stage wing has a toothed outer periphery.

4. The tape moving device for an adhesive tape holder as claimed in claim 1, wherein a front one of said two half shells is formed with a curved position groove in its wall near said handle, a position piece is provided at an inner side of said front half shell, said position piece has its one end facing said curved position groove, and a limit button screws firmly with said position piece through said position groove to let said limit button move along said position groove up and down and then is screwed unmovable at any point of said position groove.
